(19) United States
(12) Patent Application Publication
(10) Pub. No.: US 2002/0166723 A1
(43) Pub. Date: Nov. 14, 2002

(54) Adapter for connection between vehicle and ladder

(75) Inventor: Ronald L. Huber, Brainerd, MN (US)

Correspondence Address: ROBERT J JACOBSON PA, 650 BRIMHALL STREET SOUTH, ST PAUL, MN, 551161511

(73) Assignee: Carol A. McKee

(21) Appl. No.: 09/851,855

(22) Filed: May 9, 2001

(51) Int. Cl. E06C 5/00

(52) U.S. Cl. 182/127; 182/92; 182/150

(57) ABSTRACT

An adapter to permit a ladder to placed in an operating position on a vehicle, wherein the vehicle acts as a base for the ladder. The adapter is engaged to the hitch of the vehicle. The adapter includes a first removable shaft that is slid through a tubular rung at the bottom of the ladder. The adapter includes peripheral devices. One peripheral device is a tether that is engaged between the vehicle and the upper end of the ladder. The tether includes a ratchet mechanism for shortening and lengthening the tether and for changing an angle of the ladder relative to the ground. Another peripheral device is a second removable shaft for being slid through an upper rung of the ladder and for being engaged by the tether. Still another peripheral device is a leg for being placed between the adapter and the ground to minimize the chances of the front end of the vehicle from being raised when a user is on the upper end of the ladder and when the ladder has been extended.

### FIELD OF THE INVENTION

The present invention relates generally to an adapter for connection between a vehicle and a ladder such that the vehicle acts as a base for placing the ladder in an operating position and, more specifically, relates to an adapter that is engaged to the hitch of the vehicle.

### BACKGROUND OF THE INVENTION

An overhanging branch that includes dead wood that should be cut is an example of a problem. One may choose to use an extension ladder and prop the upper end of the extension ladder against the overhanging branch, yet the overhanging branch may be dead and brittle itself. Or the upper end of the extension ladder may barely reach the overhanging branch, which may swing to and from with the wind. Or the ground on which the bottom end of the ladder is placed may be wet with the dew, or may slope away from the trunk of the tree.

An overhanging branch is an example of an object that is placed “in the middle of nowhere,” but there are problems placing ladders against structures such as houses. The upper ends of ladders may break windows. Ladders themselves may fall into picture windows that look out from living and dining rooms. Ladders crush gutters. Ladders catch on electrical wires or cables running into the house. These examples illustrate but a few of the problems using the exterior of a house as a functional support for a ladder.

### SUMMARY OF THE INVENTION

A feature of the present invention is the utilization of a vehicle as a base for a ladder in a functional position.

Another feature of the present invention is an adapter for connection between a vehicle and a ladder such that the vehicle is used as a base for the ladder that is placed in an operating position.

Another feature of the present invention is the provision in such an adapter, of a hitch connection to permit the adapter to be connected to the hitch of the vehicle.

Another feature of the present invention is the provision in such an adapter, of a removable first shaft, wherein the first shaft may be partially removed from the adapter, slid through the tubular bottom rung of a ladder, and then engaged again with the adapter to fix a bottom end of the ladder to the adapter.

Another feature of the present invention is a tether for engaging the upper end of the ladder to the vehicle. The tether may be connected directly to an upper portion of the ladder or connected to a second shaft that has been slid through an upper tubular rung of the ladder. The tether may include ratchet mechanisms to lengthen or shorten the tether so as to change the angle of the ladder relative to the ground.

Another feature of the present invention is a leg for the adapter. The leg extends downwardly from the adapter to the ground. The leg supports and holds up the rear end of the vehicle and thereby holds down the front end of the vehicle when a person is on the upper (perhaps extended) end of the ladder. The weight of such a person acts as a force that tends to raise the front end of the vehicle.

Another feature of the present invention is an oblique plate mounted on the adapter so as to minimize the chances of the bottom end of the ladder swinging in a first direction away from the base portion of the adapter. Swinging of the bottom end of the ladder in the second direction is permitted, as such swinging is controlled by the shortening and lengthening of the tether that controls the angle of the ladder relative to the ground.

An advantage of the invention is safety. A vehicle, not a overhanging branch or the decorative or dangerous exterior of a house, serves as a base for a ladder. A vehicle, even a compact car, is relatively heavy and is therefore relatively safe. The ladder, when fixed to a vehicle through the adapter, is relatively sturdy.

Another advantage of the invention is cost. The present invention is relatively inexpensive to manufacture.

Another advantage is simplicity. The present invention is relatively easy to manufacture and simple to use. With the present adapter, a ladder is easy to put up, easy to adjust, easy to climb, and easy to take down.

Another advantage is one man use. The user of the ladder and adapter can set up, climb, and take down the ladder by himself or herself. No other person is required to hold the ladder.

Another advantage is speed. The adapter is engageable quickly to the hitch, the ladder is engageable quickly to the adapter, the tether may be fastened quickly to the truck and upper end of the ladder, and the leg is quickly slideable into the adapter. Further, the tether may be quickly shortened or lengthened through the ratchet mechanism, and the leg may be quickly telescopically adjusted to reach the ground. Still further, an extension ladder may be quickly extended or retracted even though fixed to the adapter.

Another advantage is that the adapter and its peripheral equipment, such as the tether and leg peripherals, are compact for storage.

### BRIEF DESCRIPTION OF THE DRAWINGS

FIG. 1 is an environmental view showing the adapter connected between a pickup truck and a ladder placed in an operating position.

FIG. 2 is a perspective view of the adapter of FIG. 1.

FIG. 3 is a front view of the adapter of FIG. 2.

FIG. 4 is a rear view of the adapter of FIG. 2.

FIG. 5 is a side view of the adapter of FIG. 2 and further shows in phantom several operating positions for the ladder.

FIG. 6 is a side view of the adapter of FIG. 2.

FIG. 7 is a perspective view of an adapter peripheral for the adapter of FIG. 2, wherein the adapter peripheral is engageable to a pickup truck.

FIG. 8 is a perspective view of adapter peripherals for the adapter of FIG. 2.

FIG. 9 is a perspective view of an extension ladder, a removable shaft of the adapter of FIG. 2 wherein the removable shaft is engageable to a bottom portion of the extension ladder, and an adapter peripheral (a removable rod) for the upper portion of the extension ladder.

FIG. 10 is a side view of leg for the adapter of FIG. 2.

FIG. 11 is a perspective view of an alternate embodiment of the adapter.

### DESCRIPTION

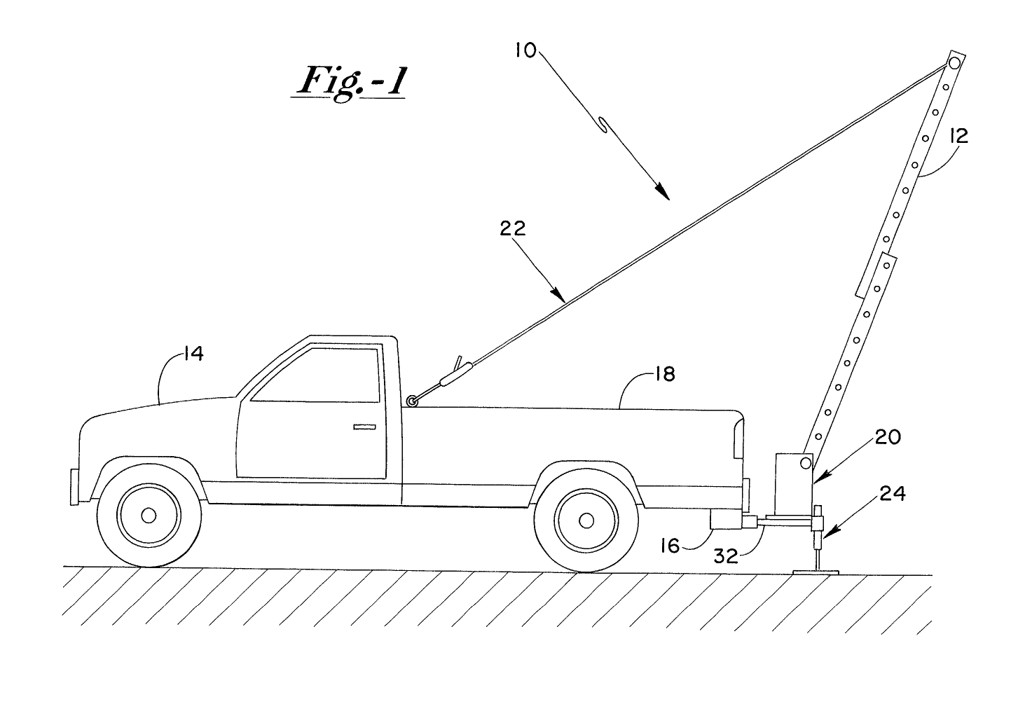

As shown in FIG. 1, an adapter kit is indicated generally by reference number 10. The adapter kit 10 is utilized to fix a ladder 12 in an operating position to a vehicle 14. The vehicle 14 is a pickup truck and includes a conventional tubular hitch 16. The hitch 16 is situated at the rear of the vehicle 14 below the bed 18 of the truck 14. The hitch 16 is rigidly fixed to the frame of the truck 14.

As further shown in FIG. 1, adapter kit 10 generally includes an adapter 20 removably engaged to the hitch 16 of the truck 14, a tether mechanism 22 for extending between the truck 14 and an upper end of the ladder 12, and a leg 24 for supporting the adapter 20 relative to the ground to minimize chances of the front end of the truck 14 being raised by the weight of a person on the upper end of the ladder.

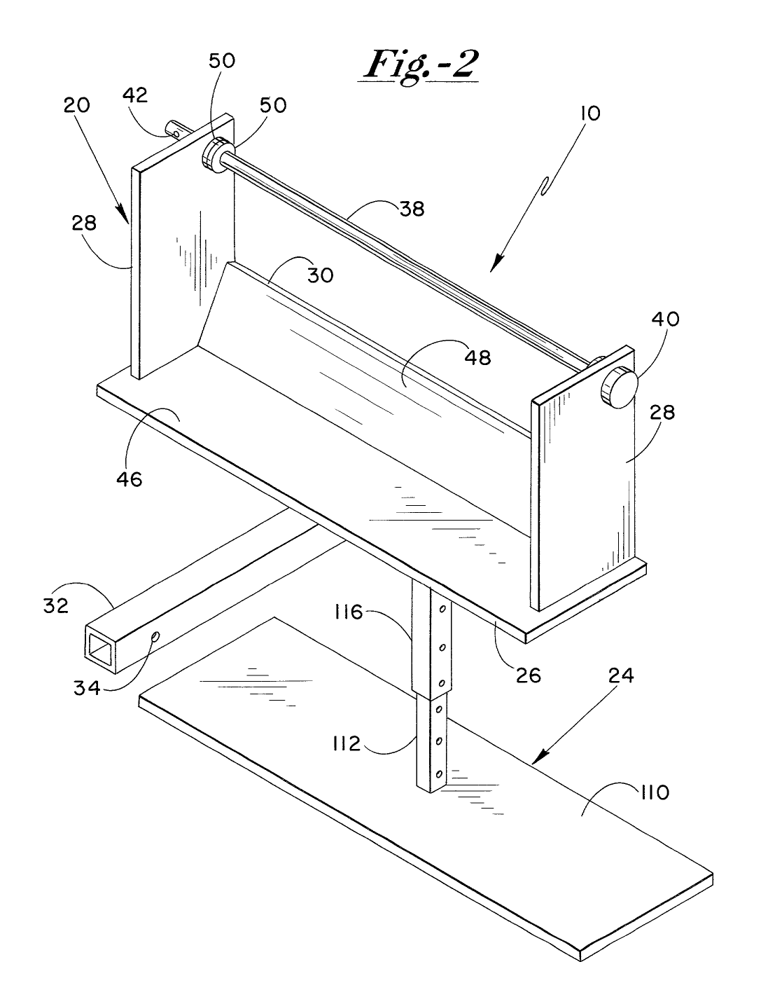

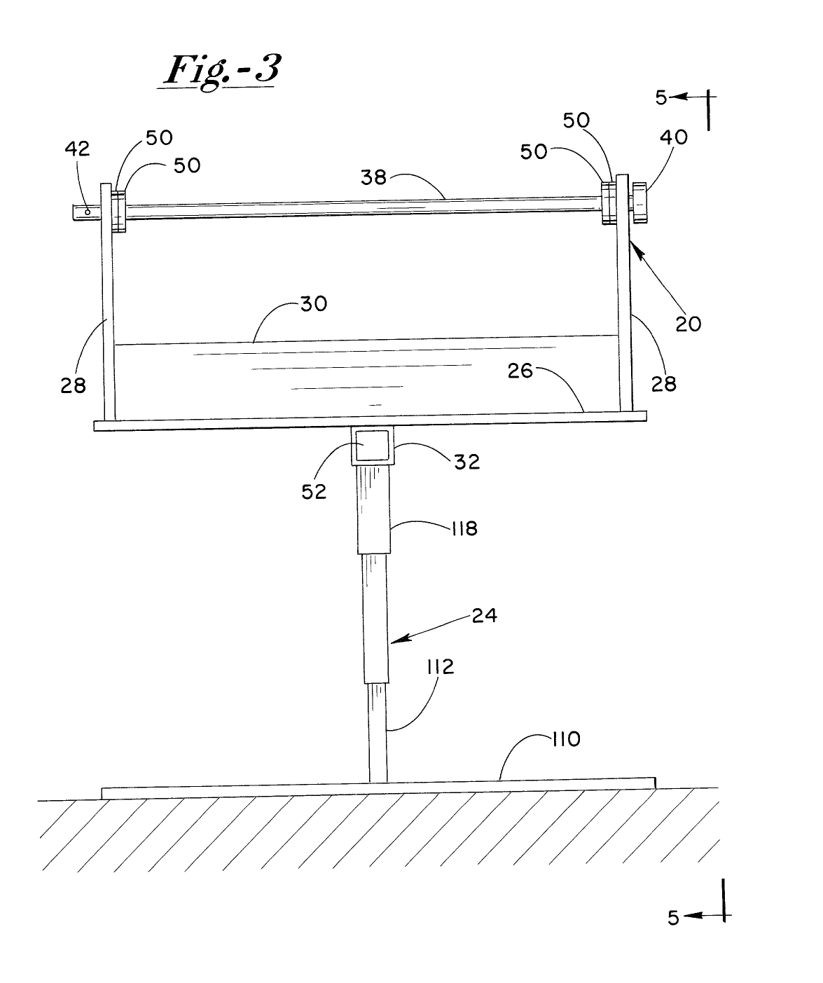

More specifically, as shown in FIG. 2, the adapter 20 includes a rectangular base plate 26 on which are rigidly affixed, such as by welding, a pair of upright support plates 28. A transversely extending stop plate 30 is rigidly fixed, such as by welding, to an upper face of the base plate 26 and to and between the upright support plates 28. Transversely extending stop plate 30, together with base plate 26, fixes the upright support plates 28 rigidly. A rigid tubular beam 32 is fixed, such as by welding, to a lower face of the base plate 26. The tubular beam 32 includes an aperture 34 running through two walls of the beam 32. Beam 32 is sized so as to slide into the tubular hitch 16. Aperture 34 is then aligned with an aperture in the truck's hitch 16 and a pin is then inserted through the aligned apertures so as to fix the adapter 20 to the hitch 16. Each of the upright support plates 28 have openings 36 (shown in FIG. 6) for receiving a removable shaft 38. Removable shaft 38 includes a cap 40 rigidly fixed thereto for preventing the shaft 38 from being slid in one direction off its respective upright support plate. Removable shaft 38 includes on its other end, the end opposite of the fixed cap 40, an aperture 42 (shown in FIG. 3) for receiving a removable pin 44 (shown in FIG. 6). When engaged in the aperture 42, removable pin 44 prevents the removable shaft 38 from being slid off of the upright support plates 28. Removable shaft 38 is slid through a tubular bottom rung of ladder 12. The feet of the ladder 12 may rest upon an upper face portion 46 of base plate 26 or may rest upon a face portion 48 of oblique plate 30. A swinging of the feet or lower portion of the ladder 12 in one direction is prevented by the oblique plate 30. Plate 30 is mounted obliquely relative to the base plate 26 because the ladder 12 is generally set relatively parallel to oblique plate 48. Further, the oblique plate 30 is positioned immediately underneath of the shaft 38 to accommodate the thickness of the ladder 12 and to discourage the ladder 12 from being set up perpendicular to the ground. A swinging of the feet or lower portion of the ladder 12 in the other direction, i.e., away from the face portions 46 and 48 is permitted. This swinging is controlled by the tether mechanism 22.

FIG. 3 shows a front view of the adapter 20, i.e., the face of the adapter 20 closest to the hitch 16 of the truck 14. As can be noted, the tubular beam 34 is square in section. The tubular hitch 16 is also square in section. The outer faces of the beam 34 confront the inner faces of the hitch 16 so as to prevent rotation or spinning of the adapter 20 relative to the truck 14. Further, the leg 24 assists in preventing a rotation or spinning of the adapter 20 relative to the truck 14 along beam 34. As can be further noted, beam 34 is fixed at the center of the base 26 and is equidistant from each of the upright support plates 28 such that the adapter 20 is well balanced. Further, FIG. 3 shows relatively thick washers 50 removably mounted on shaft 38 to accommodate ladders 12 of different widths and to mount ladder 12 centrally on base plate 26 and equidistant from each of the upright support plates 28 such that the ladder 12 is centered over beam 34 and over hitch 16 and therefore centrally relative to truck 14. With washers 50, transverse movement of the ladder 12 on shaft 38 is minimized as the washers 50 have a size greater than the inner dimension of the tubular rung of ladder 12. Further, it can be appreciated that upright support plates 28 are set in equidistant from the ends of the base plate 26 so as to keep the adapter 20, which may be relatively heavy, well balanced.

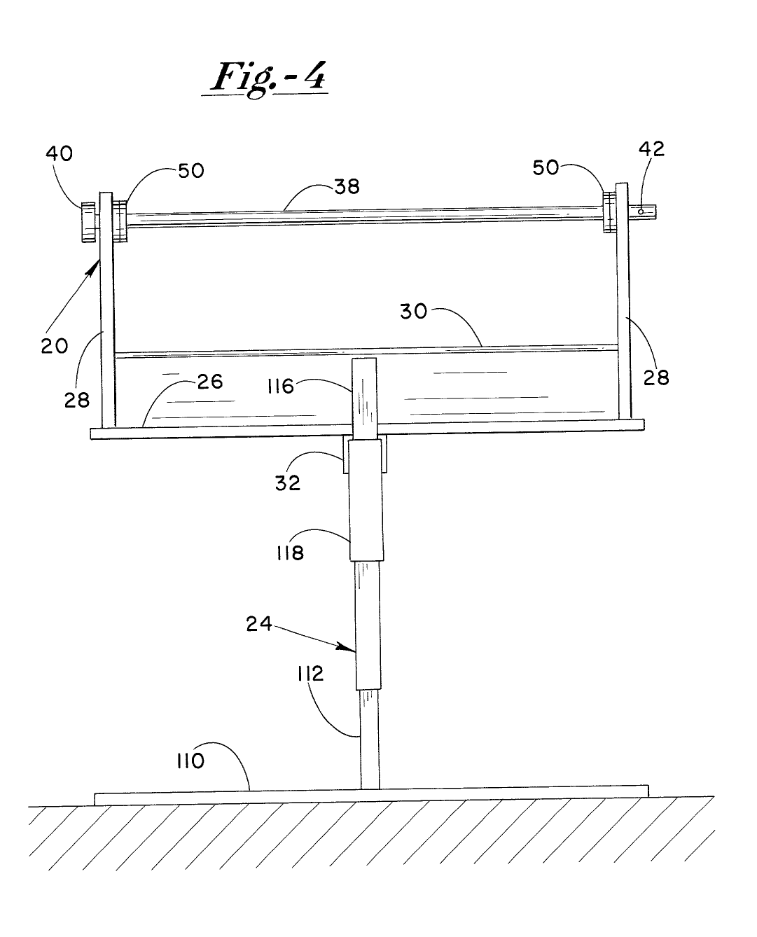

FIG. 4 shows the rear face of the adapter 20, i.e., the face of the adapter 20 that is closest to the leg 24. The beam 34 includes an opening 52 (shown in FIG. 3) for engagement with the leg 24. Opening 52 is square in section.

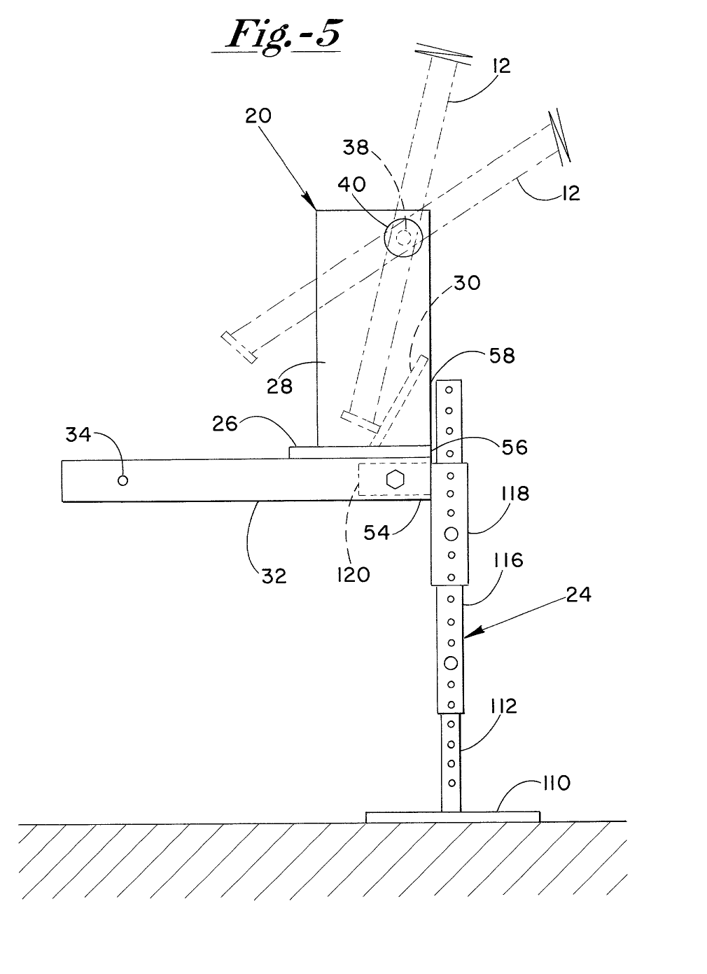

FIG. 5 is a side view of the end of the adapter 20 having the cap 40, and FIG. 6 is a side view of the end of the adapter 20 having the pin 44. FIGS. 5 and 6 show the position of the shaft 38 (welded to the cap 40) relative to the oblique stop plate 30. FIGS. 5 and 6 further show that the beam 32 is relatively long to provide an relatively long elongate connection between the hitch 16 and the adapter 20. Beam 32 is further sufficiently long to extend across the full width of the base plate 26 and the entire width of the support plates 28. A rear end 54 of the beam 32 terminates at the rear edges 56 and 58 of the base plate 26 and upright support plates 28, respectively, so as to permit leg 24, a portion of which slides into beam end 54, to be fixed as directly as possible under upright plates 28 and the bottom end of the ladder 12. FIGS. 5 and 6 further show an aperture 59 in beam end 54 for being aligned with an aperture in leg 24. A pin inserted in 5 such aligned apertures fixes the adapter 20 to leg 24.

FIG. 5 further shows how the ladder 12 can be pivotably placed in a multiple number of positions relative to the adapter 20. Stop plate 30 prevents the bottom end of the ladder 12 from swinging in a first direction relative to the adapter 20. Swinging of the bottom end of the ladder 12 in a second direction (opposite of the first direction) is controlled by the tether 22.

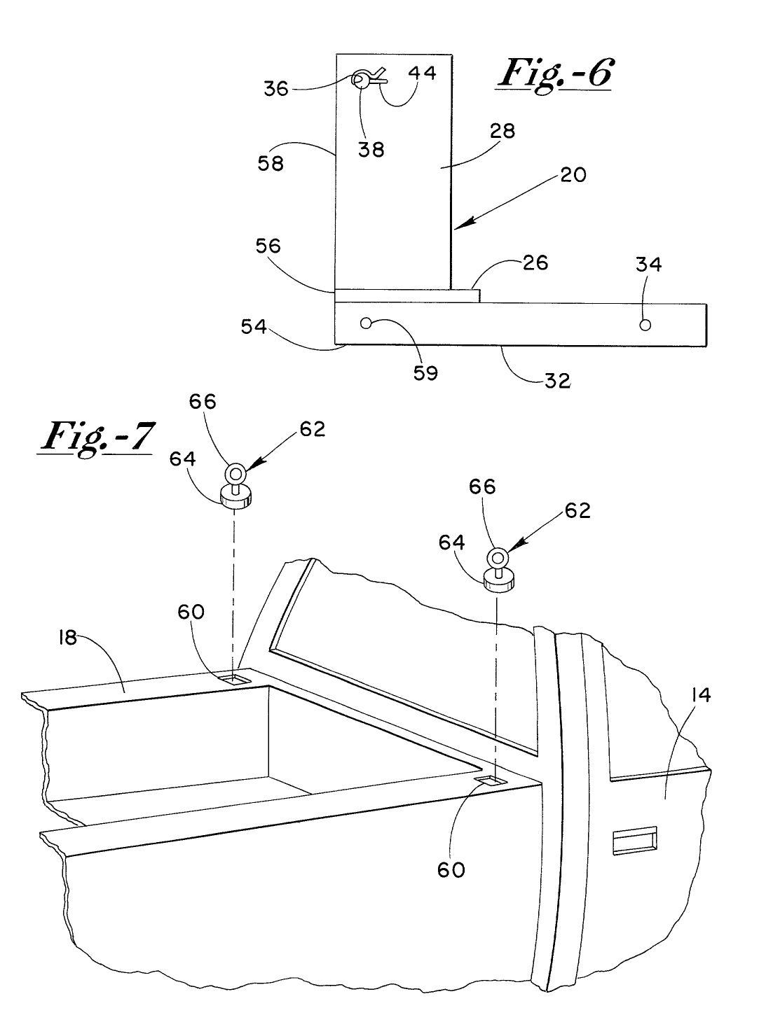

FIG. 7 is a perspective view of a portion of the bed 18 of the truck 14 and a portion of the cab of the truck 14. The bed 18 of the truck 14 includes vehicle eyelets 60 on either side of the bed 18 for receiving pins 62. Pins 62 are part of the tether mechanism 22. Each of the pins 62 includes a catch 64 and a pin eyelet 66. Catch 64 may be biased to an open position away from the post of the pin 62 so as to keep the pin 62 anchored in the vehicle eyelet 60. Pin 62 may be removed from vehicle eyelet 60 by pinching the catch 64 and the post of pin 62 together.

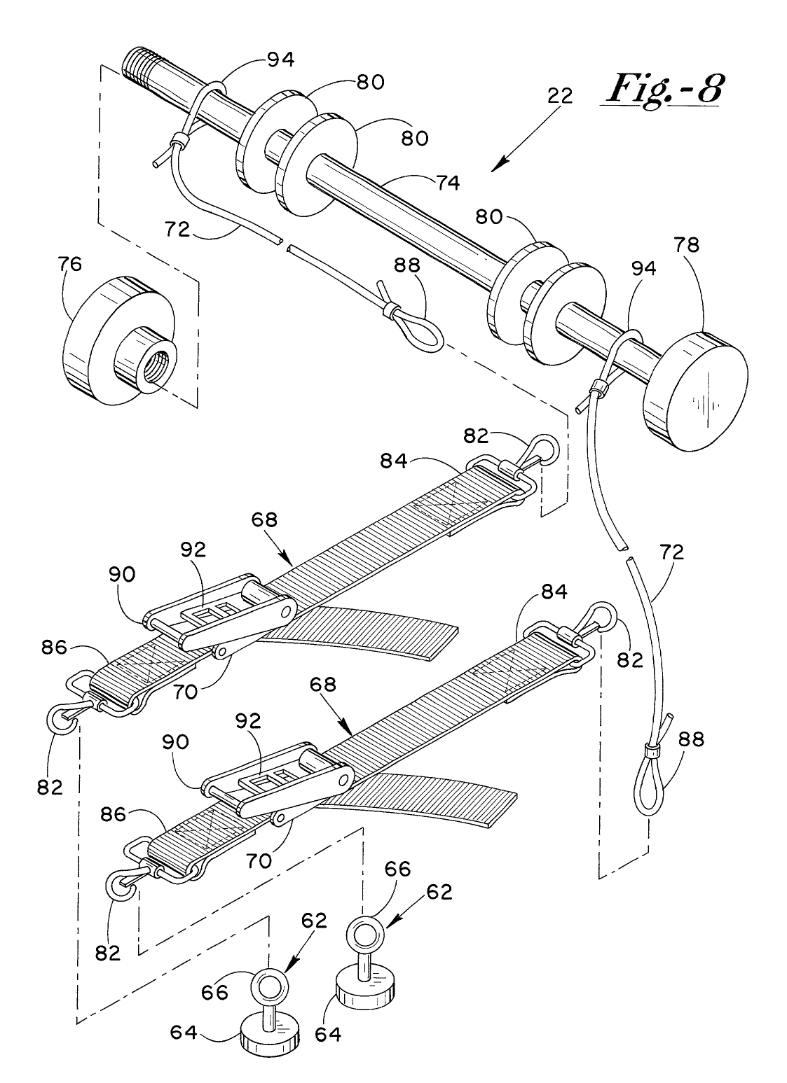

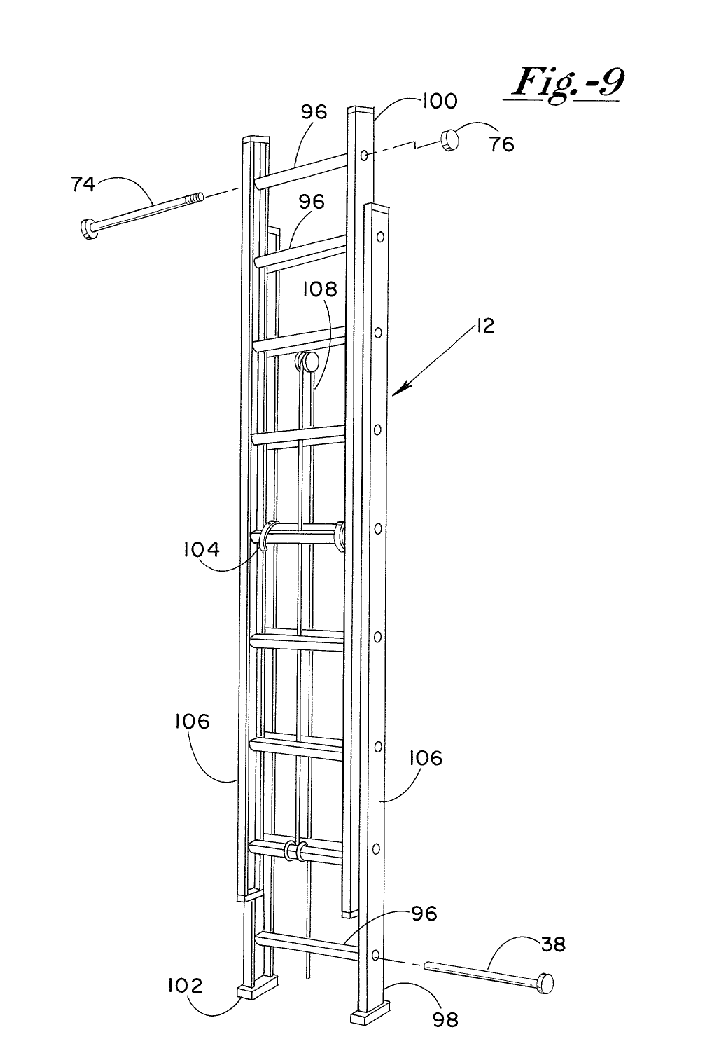

FIG. 8 is a perspective view of the tether mechanism 22. Tether mechanism or extendable member 22 includes the pair of pins 62, a pair of tethers 68 with each of the tethers 68 having a ratchet mechanism 70, a pair of tether portions 72, and a second removable shaft 74 having removable end cap 76, fixed end cap 78 and washers 80. More specifically, tether 68 includes a spring loaded quick connector or clip 82 at each of its ends 84, 86. Clip 82 easily clips to and from pin eyelet 62 and easily clips to and from a loop 88 of tether portion 72. Ratchet mechanism 70 permits the tether 68 to be lengthened and shortened incrementally. A first lever 90 of the ratchet mechanism 70 winds up the strap of the tether 68 incrementally so as to shorten the tether 68. A second lever 92 of the ratchet mechanism 70 releases internal locks of the ratchet mechanism 70 so as to permit the strap of the tether 68 to be let out incrementally so as to lengthen the tether 68. Ratchet mechanism 70 is automatically biased toward a locked position such that, when either of the levers 90 or 92 is released, the lengthening or shortening of the strap of the tether 68 ceases. Tether portion 72 includes the loop 88 and further includes a loop 94 for engaging the second removable shaft 74. Loops 94 are engaged at the ends of the second shaft 74. For example, from the outside in, the tether mechanism 22 includes first the fixed end cap 78, then the loop 94 of one tether portion 72, then one or several washers 80, then one side of the ladder 12 (or outer edge of the ladder rung) such that the washers 80 minimize lateral slippage of the loop 94 relative to the ladder 12. From the outside in on the other side of the ladder 12, the tether mechanism 22 includes the removable end cap 76, the loop 94 of the other tether portion 72, the washers 80 and then the other side of the ladder 12 (or outer edge of the ladder rung). Again, the washers 80 minimize lateral slippage of the other loop 94 relative to the ladder 12. Washers 80 are of a sufficiently great size so as not to slip into the inside of the rungs of the ladder 12. Washers 80 pinch loop 94 between themselves and the respective end cap 76 or 78.

As to the ratchet mechanism 70, the following U.S. Patents are hereby incorporated by reference in their entireties: the Huber U.S. Pat. No. 3,718,315 issued Feb. 27, 1973 and entitled Strap Adjuster Devices and the Bronson et al. U.S. Pat. No. 4,155,537 issued May 22, 1979 and entitled Adjustable Length Strap Tie Down Apparatus.

FIG. 9 shows the ladder 12 in relation to the first and second removable shafts 38 and 74. Ladder 12 includes rungs 96. Each of the rungs 96 is tubular or hollow such that the first and second removable shafts 38 and 74 may be slid into any of the rungs 96. When in their respective rungs 96, shafts 38 and 74 are pivotable such that the angle of the ladder 12 relative to the adapter 20 may be changed and such that the angle of the tether 22 relative to the ladder 12 may be changed. The ladder 12 is an extension ladder having a first lower portion 98 and a second upper portion 100. The ladder 12 further includes feet or shoe rests 102 that may make contact with base plate 26 and/or oblique plate 30, spring loaded locks 104 to prevent the upper portion 100 from slipping down, sides or side rails 106, and a pulley mechanism 108 for extension of the upper portion 100 or for slowly permitting retraction of the upper portion 100 into the lower portion 98 of the ladder 12. It should be noted that the pulley mechanism 108 can be operated while the first and second removable shafts 38 and 74 are engaged in their respective ladder rungs 96 and while the tether mechanism 22 is engaged to and between the vehicle 14 and the upper end of the ladder 12.

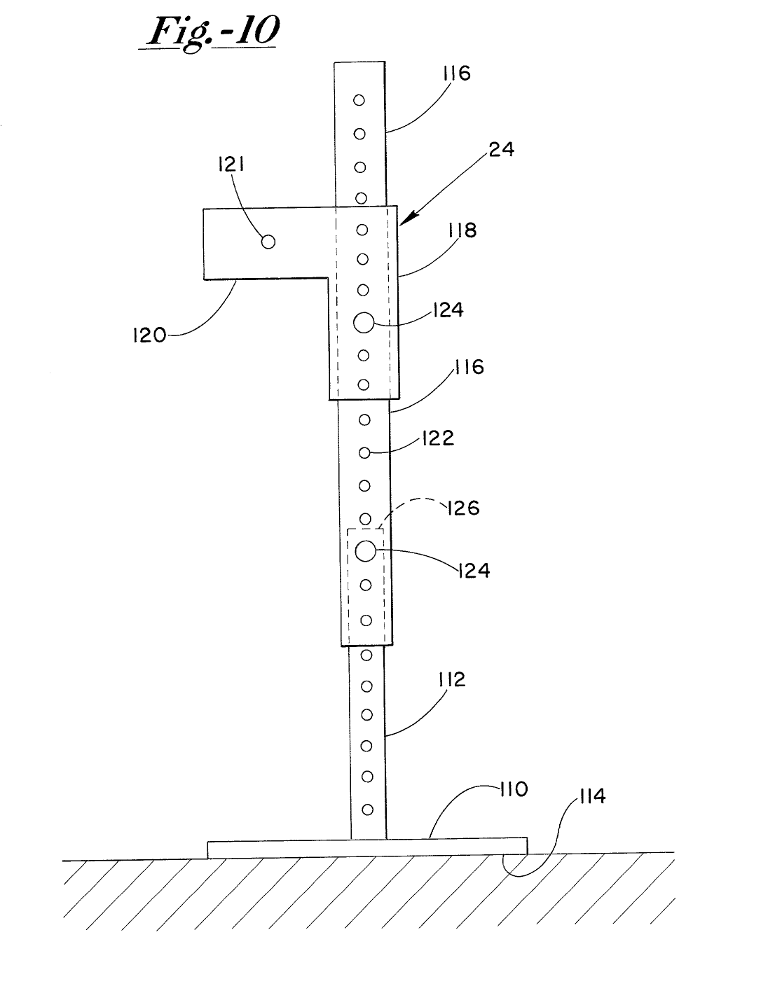

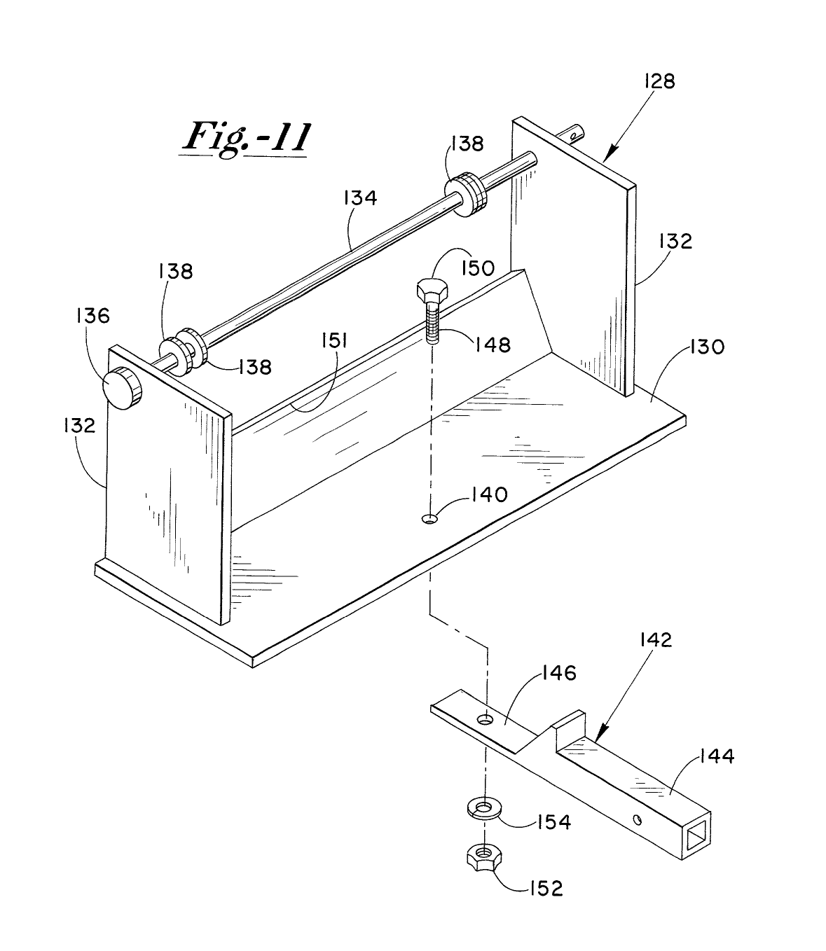

FIG. 10 shows the leg 24. Leg 24 includes a base 110 having a first upright telescoping portion 112. Base 110 is relatively wide and includes a relatively great surface area on its bottom face 114 so as to bring pressure to bear over a relatively great amount of the ground, whether the ground is grass and soil, concrete, asphalt, gravel, bricks or some other surface. Leg 24 further includes a second upright telescoping portion 116 that slides over telescoping portion 112. Leg 24 includes a third telescoping portion 118 that slides over telescoping portion 116 and that includes a rigid extension 120. Rigid extension 120 is square in section and fits into opening 52 (shown in FIG. 3). Extension 120 includes a sufficient elongate length to be positioned immediately under the first removable shaft 38 and is sized such that its outer square shaped surface confront closely the inner square shaped surface of beam 34 to prevent any rotation or spinning of the adapter 20 relative to the leg 24. Extension 120 includes an aperture 121 for cooperating with aperture 59 (shown in FIGS. 5 and 6). A pin inserted into such aligned apertures fixes the adapter 20 to the leg 24. Telescoping portions 112, 116 and 118 have cooperating apertures 122 through which pins 124 such that the leg 24 may be lengthened or shortened depending upon the height of the ground underneath the adapter 20 relative to the vehicle 14. Reference number 126 represents the upper end of the lower telescoping portion 112. However, if desired, the lower telescoping portion 112 may extend the entire height or more of telescoping portion 116. Telescoping portions 116 and 118 are tubular. Telescoping portion 112 is preferably tubular. It should be noted that, if telescoping portion 112 runs the entire height of telescoping portion 116, then telescoping portion 116 may be eliminated. However, three telescoping portions 112, 116 and 118 are preferred such that height adjustment of the leg 24 may be made at either end of the leg 24, i.e., between telescoping portions 116 and 112 or between telescoping portions 116 and 118.

FIG. 11 shows an alternate embodiment of the present invention. Here, an adapter 128 includes a base plate 130, upright support plates 132, a first removable shaft 134 mounted to and between the upright support plates 132, a fixed end cap 136 (and a removable pin at the other end of the shaft 134), and washers 138 for minimizing lateral slippage of the ladder 12. Further, adapter 128 includes a hitch aperture 140 located centrally in the base plate 130 and equidistant between the upright support plates 132. Via the hitch aperture 140, the adapter 128 is mounted to a ball hitch 142. Ball hitch 142 includes a tubular frame portion 144 for mating with the hitch 16 of the vehicle 14 (shown in FIG. 1) and a base frame portion 146 for releasably securing a bolt 148 having a head 150. It should be noted that, if desired, adapter 128 may include a transversely extending oblique plate 151 identical to plate 30 of adapter 20. To attach this embodiment, bolt 148 is removed from its base frame portion 146, then aperture 140 and the adapter 128 is oriented relative to the hitch 142 so that the base plate 130 lies on base frame portion 146 of the ball hitch 142, and then the bolt 148 is slid through aperture 140 and anchored to base frame portion 146 with a nut 152 and lock washer 154.

In operation, the vehicle 14 is driven to the intended location. Then the adapter 20 is engaged to the hitch 16. Then the leg 24 is engaged to the adapter 20 and the telescoping portions 112, 114 and 116 are adjusted so as to set the base 114 of the leg 24 firmly against the ground. Then the bottom end of the ladder 12 is connected to the adapter 20, with the ladder 12 lying on the ground and extending away from the bed 18 of the truck 14. The ladder 12, if an extension ladder, may be in its most retracted position. Then the second shaft 74 is engaged to the upper end of the ladder 12 along with the tether portions 72 and the posts 62 are engaged to the truck eyelets 60. Then the tethers 68 are lengthened to as to extend the length between the truck eyelets 60 and the upper end of the ladder 12 when the ladder 12 is lying on the ground away from the bed of the truck 14. Then the clips 82 of the tethers 68 are clipped to the truck eyelets 60 and to the loops 88 of the tether portions 72. Then the ratchet mechanisms 70 are operated to draw the ladder 12 upwardly from its prone position to its operating, inclined position, such as the position shown in FIG. 1.

After the ladder 12 is in its operating position such as shown in FIG. 1, a user may use the pulley mechanism 108 to pull out the upper portion 100 of the ladder 12 and thereby extend the ladder 12. A user may also lengthen or shorten the tethers 68. When the tethers 68 are lengthened or shortened, the upper end of the ladder 12 is raised or lowered and the angle of the ladder 12 relative to the ground changes. When the pulley mechanism 108 is operated, the upper end of the ladder 12 is raised or lowered. Accordingly, utilizing a combination of adjustments of the pulley mechanism 108 and the tether mechanism 22, the desired height and position of the upper end of the ladder 12 may be obtained. Further, the vehicle 12 may be driven forwardly or rearwardly for short distances with the base 114 slightly elevated and with the ladder 12 in an operating position as shown in FIG. 1.

After the ladder 12 is in its operating position and the upper end of the ladder 12 is adjacent the desired work location, a user may climb the rungs 96 of the ladder 12. When the user climbs, the ladder 12 does not spin or rotate, due to the connection between the adapter 20 and the hitch 16. Nor does the ladder 12 slide laterally relative to the adapter 20. Nor does the ladder 12 fall, due to the tether mechanism 22 and the internal locks of the ratchet mechanism 70. As the user reaches the top of the ladder 12, the weight of the user may tend to act as a lever to drive the front end of the vehicle 14 upwardly, but such a force is countered and minimized by the leg 24, which prevents the rear end of the vehicle 14 from being driven downwardly and thereby prevents the front end of the vehicle 14 from being raised.

During work at the desired elevated location, the user may climb down the ladder 12, adjust the location and height of the upper end of the ladder 12 by using one or both of the tether mechanism 22 and pulley mechanism 108 or by driving the vehicle 14 for short distances, and then climb back up the ladder 12 to work at an adjacent elevated location.

After work at the desired location is complete, the ladder 12 may be taken down by slowly retracting the upper portion 100 of the ladder 12 by using the pulley mechanism 108, then slowly lowering the ladder 12 from its inclined position by utilizing the tether mechanism 22, then removing the tether mechanism 22 from the ladder 12 and vehicle 14, then removing the ladder 12 from the adapter 20, then removing the leg 24 from the adapter 20, then removing the adapter 20 from the hitch 16.

It should be noted that, if desired the tethers 68 may be crisscrossed when connected between the vehicle 14 and the ladder 12 so as to form an “X.” Or a “Y” shaped tether may be employed where the base of the “Y” is fixed to the vehicle 12 and operated by a single ratchet mechanism 70. The branches of the “Y” tether are fixed to respective sides of the ladder 12 and the lengthening and shortening of the branches are controlled by the single said ratchet mechanism 70.

It should further be noted that leg 24 may not be required, depending upon the weight of the user, the weight of the vehicle 14, and the length to which the upper portion 100 of the extension ladder 12 is extended.

It should further be noted that the tether mechanism 22 may not be required. For example, the upper end 100 of the extension ladder 12 may be leaned against a side of a house or against a branch of a tree or against another structure.

It should be noted that one end of the tether 68 may be affixed directly to the truck eyelets 60 (without the intermediate pins 62) and the other end of the tether 68 may be affixed directly to the upper end of the ladder 12 or to any other portion of the ladder 12. When so affixed directly to the ladder 12, it is preferably if one tether 68 is wound about one side rail 106 and a rung 96 and if the other tether is wound about the other side rail 106 and the same rung 96 to keep the tethers 68 at the same height and to keep the tethers 68 spaced apart. After being wound about the side rail 106 and rung 96, the clip 82 of the tether 68 is clipped to the strap of its own tether 68. Likewise, depending on the size of the clip 82 and the size of the truck eyelet 60, the clip 82 may be pushed into truck eyelet 60 and then out into the bed of the truck 14, whereupon the clip 82 is clipped to the strap of its own tether 68.

The truck eyelets 60 may be referred to as stake pockets 60. As to the pins 62, which may be referred to as tie down anchors, the following U.S. patents are hereby incorporated by reference in their entireties: U.S. Pat. No. 4,812,093 issued Mar. 14, 1989 to Millar, Jr. and entitled Stake Pocket Tie-Down Anchor and U.S. Pat. No. 4,607,991 issued Aug. 26, 1986 to Porter and entitled Tie-Down Anchor For Truck Bed.

It should further be noted that base 110 of leg 24 may have less surface area (i.e., have a smaller size). For example, base 110 may be square in shape and its side edges may be about one-half the length between upright support plates 28. Or for example, each of the side edges of the base 110 may measure from about six inches to about 12 inches to about 18 inches. If a relatively small base is used, dimensional lumber may be slipped under the base 110 to keep the rear end of the vehicle 14 from pressing the base 110 into soft ground.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalents of the claims are intended to be embraced therein.

I claim:

1. An adapter for mounting a ladder in a functional position on a vehicle, wherein the vehicle comprises a hitch, wherein the ladder comprises a tubular rung and first and second ends, wherein the adapter comprises:
a) a frame engageable to the hitch and comprising a base portion and a pair of support portions, wherein the support portions extend transversely of the base portion; and
b) a shaft engageable to and between the support portions and being spaced from the base portion, wherein the shaft is sized to extend through the tubular rung of the ladder;
c) wherein the frame is engaged to the hitch and wherein the shaft is slid into the tubular rung on the first end of the ladder to mount the ladder in a functional position to the vehicle.

2. The adapter according to claim 1, wherein the frame further comprises a stop portion fixed at an angle relative to the base portion to confront the first end of the ladder to prevent a swinging of the first end of the ladder away from the base portion in a first direction.

3. The adapter according to claim 1, wherein the adapter further comprises a tether engageable between the vehicle and the second end of the ladder, wherein the tether controls a swinging of the first end of the ladder relative to the base portion in a second direction such that an angle of the ladder relative to the vehicle can be controlled.

4. The adapter according to claim 2, wherein the adapter further comprises a tether engageable between the vehicle and the second end of the ladder, wherein the tether controls a swinging of the first end of the ladder relative to the base portion in a second direction such that an angle of the ladder relative to the vehicle can be controlled.

5. The adapter according to claim 1, wherein the tether can be lengthened or shortened to change an angle of the ladder relative to the vehicle.

6. The adapter according to claim 1, wherein the second end of the ladder includes a tubular rung, and wherein the adapter further comprises a second shaft having two ends, wherein the second shaft is insertable through the tubular rung of the second end of the ladder and wherein the tether is engageable to at least one of the two ends of the second shaft.

7. The adapter according to claim 1, and further comprising a leg, wherein the leg is engaged to the frame and extends downwardly therefrom to the ground to minimize chances that one end of the vehicle will be pushed up by a weight of a person on the second end of the ladder pushing down on the other end of the vehicle.

8. The adapter according to claim 7, wherein the leg can be lengthened and shortened.

9. An adapter kit for mounting a ladder in a functional position on a vehicle, wherein the vehicle comprises a hitch, wherein the ladder comprises lower and upper ends, wherein the adapter kit comprises:
a) an adapter comprising a frame engageable to the hitch;
b) a rigid member engaged to the frame of the adapter, wherein the rigid member removably and pivotably engages the lower end of the ladder to the adapter and hence to the vehicle; and
c) an extendable member extending to and between the vehicle and the upper end of the ladder, wherein the extendable member removably engages the upper end of the ladder to the vehicle, wherein the extendable member is extendable and retractable so as to pivot the lower end of the ladder relative to the adapter and so as to change an angle of inclination of the ladder.

10. The adapter kit according to claim 9, wherein the extendable member comprises a tether.

11. An adapter kit for mounting a ladder in a functional position on a vehicle, wherein the vehicle comprises a hitch, wherein the ladder comprises lower and upper ends, wherein the adapter kit comprises:
a) an adapter comprising a frame engageable to the hitch;
b) a rigid member engaged to the frame of the adapter, wherein the rigid member engages the lower end of the ladder to the adapter and hence to the vehicle; and
c) a leg extending to and between the adapter and the ground, wherein the leg supports the adapter relative to the ground, wherein a weight of a user on the upper end of the ladder tends to raise a front end of the vehicle and lower a rear end of the vehicle, and wherein the leg minimizes a lowering of the rear end of the vehicle and thereby minimizes a raising of the front end of the vehicle.

12. The adapter kit according to claim 11, wherein the leg is removably fixed to the adapter.

13. The adapter kit according to claim 11, wherein the leg is extendable and retractable.
